(19) United States
(12) Patent Application Publication
(10) Pub. No.: US 2026/0278090 A1
(43) Pub. Date: Sep. 17, 2026

(54) MOTHERBOARD INTEGRATED RANSOMWARE INTRUSION DETECTOR

(71) Applicant: Robert Bosch GmbH, Stuttgart (DE)

(72) Inventors: Pradeep M. PAPPACHAN, Pittsburgh, PA (US); Stefan GEHRER, Pittsburgh, PA (US); Jorge GUAJARDO MERCHAN, Pittsburgh, PA (US); Sashidhar JAKKAMSETTI, Sunnyvale, CA (US); Shalabh JAIN, Pittsburgh, PA (US)

(21) Appl. No.: 19/079,532

(22) Filed: Mar. 14, 2025

(51) Int. Cl. G06F 21/56

(52) U.S. Cl. CPC G06F 21/56; G06F 2221/034

(57) ABSTRACT

A motherboard-based ransomware intrusion detector is disclosed. The intrusion detector incudes a measurement circuit to measure power provided to a primary processor and other devices (e.g., storage, network, etc.) on the motherboard and to quantize the measurements into digital signals. The digital signals are provided to a secondary processor that executes a ransomware detection model stored on a non-volatile memory. The measurement circuit, the secondary processor, and the non-volatile memory are also implemented on the motherboard. Using the digital signals and the ransomware detection model, the secondary processor determines if a program executing on the computer system is ransomware. In response to detecting ransomware, the secondary processor causes one or more corrective actions to be taken.

### TECHNICAL FIELD

The present disclosure relates to computer systems, and more particularly, to the detection of ransomware attacks on computer systems.

### BACKGROUND

Ransomware is a type of malware that is used by malicious actors to deny a user access to his/her data until the user pays the attacker to restore the user's access to the data. There are two types of ransomware: cryptographic and locker. In the cryptographic type, ransomware encrypts a user's files with a secret key so that the files are not accessible to the user. When the user pays the demanded ransom using the attacker's payment method (e.g., crypto currency such as Bitcoin), the attacker releases the key(s) needed to decrypt the user's files. In the locker type, the victim is prevented from accessing the system by locking the screen, browser, or master boot record of the machine (preventing the OS from loading), and access is restored only when the payment is made.

Ransomware can infect a victim's machine in several ways, such as malicious emails, instant messages, SMS messages, malicious applications, malicious downloads, and system vulnerabilities. For example, in a method where user interaction is required to infect the victim's machine, it may be disguised as a Trojan in an email message communicated to the user. The email may contain a file attachment, which when downloaded to the user's machine can install ransomware on the machine. Ransomware can also propagate between machines as a worm.

### SUMMARY

A motherboard-based ransomware intrusion detection system is disclosed. In one embodiment, a ransomware detection system includes a measurement circuit configured to measure power provided from a power supply to a primary processor. The measurement circuit is configured to measure variations in power provided to the primary processor and further configured to quantize these variations (e.g., using an analog-to-digital converter) to generate quantized power signals. A non-volatile memory stores a ransomware detection model. A secondary processor is configured to execute the ransomware detection model and use the quantized power signals to determine if a program being executed by the primary processor, is ransomware. In response to determining that the program is ransomware, the secondary processor may take one or more corrective actions, including inhibiting the further execution of instructions by the primary processor. In various embodiments, the measurement circuit, primary processor, secondary processor, and non-volatile memory are all implemented on a motherboard of a computer system,

### BRIEF DESCRIPTION OF THE DRAWINGS

FIG. 1 illustrates a block diagram of an exemplary computing device, according to some embodiments of the disclosure.

FIG. 2 is a block diagram illustrating one embodiment of a computer system implemented on a motherboard and including a ransomware detection system in accordance with the disclosure.

FIG. 3 is a block diagram illustrating a number of networked computers including at least one having a ransomware detection system implemented thereon, in accordance with the disclosure.

FIG. 4 is a flow diagram illustrating an embodiment of a method for operating a ransomware detection system.

FIG. 5 is a flow diagram illustrating another embodiment of a method for operating a ransomware detection system.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative bases for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical application. Various combinations and modifications of the features consistent with the teachings of this disclosure, however, could be desired for particular applications or implementations.

“A”, “an”, and “the” as used herein refers to both singular and plural referents unless the context clearly dictates otherwise. By way of example, “a processor” programmed to perform various functions refers to one processor programmed to perform each and every function, or more than one processor collectively programmed to perform each of the various functions.

Ransomware is a type of malware that is used by malicious actors to deny a user access to his/her data until the user pays the attacker to restore the user's access to the data. Two common types of ransomware are cryptographic and locker. In the cryptographic type, ransomware encrypts a user's files with a secret key so that the files are not accessible to the user. When the user pays the demanded ransom using the attacker's payment method (e.g., crypto currency such as Bitcoin), the attacker releases the key(s) needed to decrypt the user's files. In the locker type, the victim is prevented from accessing the system by locking the screen, browser, or master boot record of the machine (preventing the OS from loading), and access is restored only when the payment is made.

Ransomware can infect a victim's machine in several ways, such as malicious emails, instant messages, SMS messages, malicious applications, malicious downloads, and system vulnerabilities. For example, in a method where user interaction is required to infect the victim's machine, it may be disguised as a Trojan in an email message communicated to the user. The email may contain a file attachment, which when downloaded to the user's machine can install ransomware on the machine. Ransomware can also propagate between machines as a worm.

Ransomware that encrypts a user's files typically works as follows. Once installed on a user's machine, ransomware generates an asymmetric public/private key pair (say, client public/private key). The private key of the client public key is used to encrypt the symmetric keys that will be used to encrypt the user's files. The private key is protected by a public/private key known only to the attacker (say, attacker public/private key) and never stored on the victim's machine. Ransomware traverses the file system of the user's machine, identifying files that will be encrypted. For each such file, it generates a symmetric encryption key and encrypts the file with the symmetric key. The symmetric key is encrypted using the client private key. After all the files are encrypted, the client's private key is encrypted with the attacker's public key and sent to a Command-and-Control server operated by the attacker, along with all the encrypted symmetric keys. The client public/private key and all the symmetric keys that were used to encrypt the files are deleted, leaving only the encrypted files on the user's machine; the original files are deleted or overwritten by the encrypted files.

Various methods have been developed to detect ransomware. Examples include, blacklisting methods (uses malicious domain and IP addresses), rule-based, statistics-based (uses statistics on program features), formal methods-based (uses model to discriminate between malicious and benign patterns), Machine Learning-based (uses ML models built based on structural or behavioral features of the program), and Hybrid methods (uses a combination of various methods). The present disclosure makes use of the insight that ransomware attacks may be accompanied by certain patterns in the power consumption of a computer system, and these patterns may generate a detectable signature during the initial ransomware attack. Accordingly, the present disclosure includes the use of a machine learning model that is trained to use power side channel signals to detect ransomware.

When program instructions execute on a processor, they consume power. It has been shown that each program has a distinctive power profile based on the set of unique instructions it executes. By sampling the power signals during the execution of a program, it might be possible to identify the program based on the analysis of those signals. One method of analyzing the program disclosed herein is to use a machine learning model that may be trained with a large number of power signals captured during the program's execution to recognize its distinctive signature.

It is further known that ransomware programs perform a large number of encryption and file I/O operations, leaving behind a distinct signature that can be extracted from power side channel samples captured during execution. Therefore, a machine learning model trained to detect ransomware based on power side channel signals can be deployed on a user's machine to spot ransomware as soon as it starts operating on the machine.

Capturing the power side channel signals can be challenging. Modern processors (such as Intel's x86 processors) provide Running Average Power Limit (RAPL) interfaces for reporting the power consumption information to applications. These interfaces can be used to measure the power side channel information while ransomware is running on the machine. However, there are some disadvantages to using this interface. Due to concerns over leakage of side channel information that can be used maliciously against applications running on the processor, the sampling frequency of these signals is very low and thus not sufficiently to accurately fingerprint ransomware. The other main disadvantage of using this interface is that it is reported to an application or kernel module on the machine. If the ransomware runs on the machine with kernel privilege, it can prevent the detector from collecting these samples or spoof the sample values to prevent detection.

The present disclosure is directed to systems and methods to capture side channel signals (for example, power, EM radiation, etc.) using a system components external to the main/primary processor (or processors). The ransomware detection system itself may be integrated into the motherboard of the computer system. Furthermore, the ransomware detection system may safely capture the signals at a high enough sampling rate without interference from ransomware even when it runs at the highest privilege level on the primary processor. Having the ransomware detection system on the motherboard with connectivity to an out-of-band management device (usually found on server platforms) may also provide the ability to provide timely alerts and control power to the primary processor if it needs to be suspended or shut down in response to detection of ransomware on the machine.

The ransomware detection system of the present disclosure thus includes a power measurement device implemented on a motherboard of a computer system which samples, during execution of a program by a primary processor (also implemented on the motherboard) variations in the power provided to the computer system and generate quantized power signals based thereon. Executing at least one ransomware detection model stored on a non-volatile memory, a secondary processor (also implemented one the motherboard) uses the quantized samples to determine if ransomware is executing on the primary processor. In response to detecting that ransomware is executing on the primary processor, the ransomware detection device may inhibit further instruction execution thereon. Various embodiments of such a device and variations thereof are now discussed in further detail.

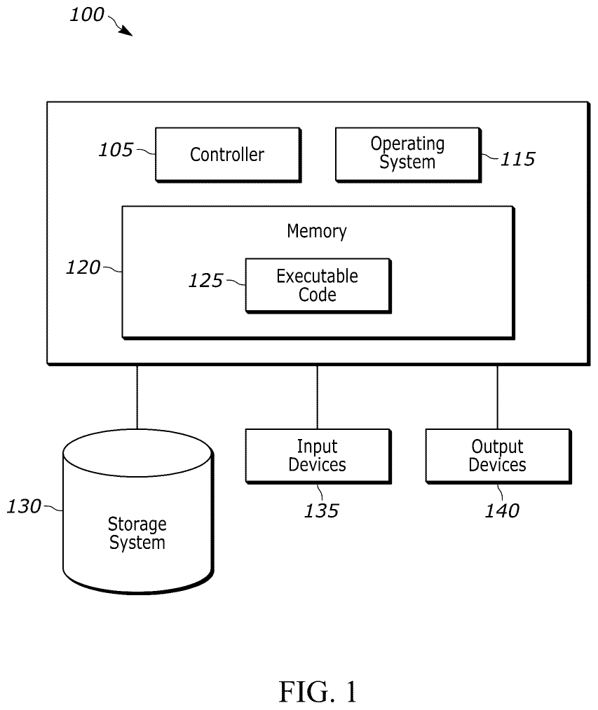

FIG. 1 illustrates a block diagram of an exemplary computing device, according to some embodiments of the disclosure. Device 100 as shown may correspond to a ransomware detection device as discussed herein, as well as a general-purpose computing device. The device 100 may include a controller 105 that may be, for example, a central processing unit processor (CPU), a chip or any suitable computing or computational device, an operating system 115, a memory 120, executable code 125, a storage system 130 that may include input devices 135 and output devices 140. Controller 105 (or one or more controllers or processors, possibly across multiple units or devices) may be configured to carry out methods described herein, and/or to execute or act as the various modules, units, etc. More than one computing device 100 may be included in, and one or more computing devices 100 may act as the components of a system according to embodiments of the disclosure. Computing device 100 may be any type of computer system capable of executing software programs. Such computer systems may include desktop computer systems, laptop computer systems, servers, electronic control units (e.g., used in vehicles), robotic systems, advance driver assistance systems (ADAS), smart phones, tablet computers, and so on.

Operating system 115 may be or may include any code segment (e.g., one similar to executable code 125 described herein) designed and/or configured to perform tasks involving coordination, scheduling, arbitration, supervising, controlling or otherwise managing operation of computing device 100, for example, scheduling execution of software programs or tasks or enabling software programs or other modules or units to communicate. Operating system 115 may be a commercial operating system. It will be noted that an operating system 115 may be an optional component; e.g., in some embodiments, a system may include a computing device that does not require or include an operating system 115. For example, a computer system may be, or may include, a microcontroller, an application specific circuit (ASIC), a field programmable array (FPGA), network controller (e.g., CAN bus controller), associated transceiver, system on a chip (SOC), and/or any combination thereof that may be used without an operating system.

Memory 120 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 120 may be or may include a plurality of, possibly different memory units. Memory 120 may be a computer or processor non-transitory readable medium, or a computer non-transitory storage medium, e.g., a RAM.

Executable code 125 may be any executable code, e.g., an application, a program, a process, task or script. Executable code 125 may be executed by controller 105 possibly under control of operating system 115. For example, executable code 125 may be an application that enforces security in a vehicle as further described herein, for example, detects or prevents cyber-attacks on in-vehicle networks. Although, for the sake of clarity, a single item of executable code 125 is shown in FIG. 1, a system according to some embodiments of the disclosure may include a plurality of executable code segments similar to executable code 125 that may be loaded into memory 120 and cause controller 105 to carry out methods described herein. Where applicable, the terms “process” and “executable code” may mean the same thing and may be used interchangeably herein. For example, verification, validation and/or authentication of a process may mean verification, validation and/or authentication of executable code.

Storage system 130 may be or may include, for example, a flash memory as known in the art, a memory that is internal to, or embedded in, a micro controller or chip as known in the art, a hard disk drive, a CD-Recordable (CD-R) drive, a Blu-ray disk (BD), a universal serial bus (USB) device or other suitable removable and/or fixed storage unit. Content may be stored in storage system 130 and may be loaded from storage system 130 into memory 120 where it may be processed by controller 105. In some embodiments, various ones of the components shown in FIG. 1 may be omitted. For example, memory 120 may be a nonvolatile memory having the storage capacity of storage system 130. Accordingly, although shown as a separate component, storage system 130 may be embedded or included in memory 120.

Input devices 135 may be or may include any suitable input devices, components or systems, e.g., physical sensors such as accelerometers, tachometers, thermometers, microphones, analog to digital converters, etc., a detachable keyboard or keypad, a mouse and the like. Output devices 140 may include one or more (possibly detachable) displays or monitors, motors, servo motors, speakers and/or any other suitable output devices. Any applicable input/output (I/O) devices may be connected to computing device 100 as shown by blocks 135 and 140. For example, a wired or wireless network interface card (NIC), a universal serial bus (USB) device, JTAG interface, or external hard drive may be included in input devices 135 and/or output devices 140. It will be recognized that any suitable number of input devices 135 and output device 140 may be operatively connected to computing device 100 as shown by blocks 135 and 140. For example, input devices 135 and output devices 140 may be used by a technician or engineer in order to connect to a computing device 100, update software and the like. Input and/or output devices or components 135 and 140 may be adapted to interface or communicate, with control or other units in a vehicle, e.g., input and/or output devices or components 135 and 140 may include ports that enable device 100 to communicate with an engine control unit, a suspension control unit, a traction control and the like.

Embodiments may include an article such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein. For example, a storage medium such as memory 120, computer-executable instructions such as executable code 125 and a controller such as controller 105.

The storage medium may include, but is not limited to, any type of disk including magneto-optical disks, semiconductor devices such as read-only memories (ROMs), random access memories (RAMs), such as a dynamic RAM (DRAM), erasable programmable read-only memories (EPROMs), flash memories, electrically erasable programmable read-only memories (EEPROMs), magnetic or optical cards, or any type of media suitable for storing electronic instructions, including programmable storage devices.

Embodiments may include components such as, but not limited to, a plurality of central processing units (CPU) or any other suitable multi-purpose or specific processors or controllers (e.g., controllers similar to controller 105), a plurality of input units, a plurality of output units, a plurality of memory units, and a plurality of storage units. A system may additionally include other suitable hardware components and/or software components. In some embodiments, a system may include or may be, for example, a personal computer, a desktop computer, a mobile computer, a laptop computer, a notebook computer, a terminal, a workstation, a server computer, a Personal Digital Assistant (PDA) device, a tablet computer, a network device, or any other suitable computing device.

In some embodiments, a system may include or may be, for example, a plurality of components that include a respective plurality of central processing units, e.g., a plurality of CPUs as described, a plurality of CPUs embedded in an on board, or in-vehicle, system or network, a plurality of chips, FPGAs or SOCs, microprocessors, transceivers, microcontrollers, a plurality of computer or network devices, any other suitable computing device, and/or any combination thereof. For example, a system as described herein may include one or more devices such as computing device 100.

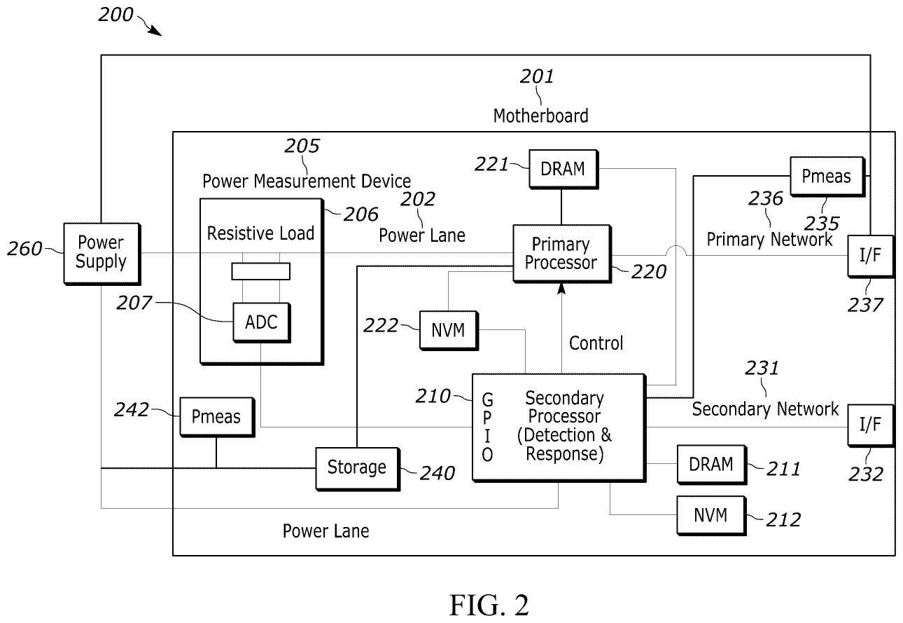

FIG. 2 is a block diagram illustrating one embodiment of a computer system implemented on a motherboard and including a ransomware detection system in accordance with the disclosure. In the embodiment shown, computer system 200 is implemented on motherboard 201, which may be any suitable type of printed circuit board (PCB) upon which the components of a computer system mounted or attached. Computer system 200 includes a primary processor 200 configured to execute program instructions. A dynamic random access memory (DRAM) 221 is coupled to primary processor, and may provide memory for accessing instructions and data during the execution of programs as well as a location to write results of executed instructions. A non-volatile memory 222 is also coupled to primary processor, and may provide instructions, such as boot code, for booting up the system. A storage device 240 is also implemented on the motherboard in this embodiment to provide bulk storage for programs and data. Storage device 240 may be implemented using flash memory, hard disk, or any other suitable bulk storage mechanism. A network interface 237 is provided to facilitate networked communications for primary processor 220 to other network-coupled devices.

A ransomware detection system implemented on motherboard 201 includes power measurement device 206, a secondary processor 210, DRAM 211, and non-volatile memory 212. Using information obtained from power provided by power supply 260 to primary processor 220 over power lane 202, the ransomware detection system may determine if ransomware is executing on the primary processor and, in response to detecting ransomware, take one or more corrective actions.

Power supply 260 may be any suitable power source for providing power to primary processor 220. In some embodiments, power supply 260 may also be implemented on motherboard 201, although it is external in this embodiment. Power supply 260 may include any suitable type of power delivery circuitry, and may be implemented as, e.g., a DC-DC converter (such as a buck converter), AD-DC converter, and so on.

Power measurement device 205 is configured to sample the potential difference across a resistive element in the path of the power lane 202 to the primary processor from the power supply 260. A resistive load 206 is implemented in power measurement device 205, either as a shunt device or directly into power lane 202. As primary processor 220 executes instructions, the power drawn over power lane 202 may vary. This is reflected in the current drawn by primary processor 220, and, in turn, the voltage across resistive load 206. Analog-to-digital converter (ADC) circuit 207 in the embodiment shown may sample the various voltages across resistive load 206, converting (quantizing) these various voltages into digital signals. The sampling rate may be sufficiently high so as to capture changes to the power drawn with high granularity that corresponds to the execution of different instructions. In some embodiments, the sampling rates and quantization levels may be variable, and may be controllable by secondary processor 210. This may allow for the sampling of different frequencies, and may further allow for oversampling for at least some frequency values.

The digital signals generated from the samples taken by ADC circuit 207 are then forwarded to secondary processor 210. In various embodiments, these digital signals may be conveyed in windows, or groups of samples. However, embodiments in which samples are provided in a steady stream from power measurement device 205 are also possible and contemplated.

Secondary processor 210 may access ransomware detection software, including a machine learning model, from non-volatile memory 212. Executing the ransomware detection software including the ransomware detection model and using the digital signals received from power measurement device 205, make a determination as to whether ransomware is executing on primary processor 220. During execution of the ransomware detection software, secondary processor 210 may utilize DRAM 211 in a manner similar to that which primary processor 220 utilizes DRAM 221 during the execution of program instructions. Both DRAM 211 and non-volatile memory 212 may be configured for exclusive use by secondary processor 210. Furthermore, secondary processor 210 may be a secure processor that does not provide any visibility to operating system software or other programs that execute on primary processor 220.

In execution of the ransomware detection software/model, secondary processor 210 may carry out various functions such as comparing a power signature within the received digital signals to power signatures associated with known ransomware programs, or detecting deviations from patterns observed in consumption of power under normal conditions (without ransomware). The ransomware detection model in various embodiments includes a classifier model, which may categorize the digital signals as being associated with different types of programs. The classification may be refined as digital signals associated with additional samples or groups of samples are received from power measurement device 205. Secondary processor 210 may, during execution of the ransomware detection program, carry out various pre-processing functions of the digital signals. For example, secondary processor 210 may perform bandpass filtering of digital signals to enable a focus on frequencies of interest while reducing processing overhead.

In response to the detection of ransomware during execution of the ransomware detection program/model, secondary processor 210 may carry out various functions for corrective and preventative actions. In one embodiment, secondary processor 220 may halt (inhibit) any further instruction execution by primary processor 220 in response to determining that ransomware is running thereon. Halting instruction execution may also include turning off power to primary processor 220. Prior to halting instruction execution and/or removing power, secondary processor 210 may convey a command to primary processor 220 to back up one or more files modified during the execution of the ransomware such that these files are available for subsequent analysis. Secondary processor 210 may also convey a responses, indicative of the ransomware detection and based on a security policy, via secondary network 231 and network interface 232 to a remote computer such as a server or other computer used by a network administrator. The response may include an alert indicating the detection of ransomware. as well as any actions taken or underway.

Detection logs may also be written by secondary processor 210 to the non-volatile memory 212 to indicate the results of running the ransomware detection program. Such detection logs may include the raw data from digital signals used to make the detection, as well as data generated by, e.g., a classifier in the ransomware detection model. The ransomware detection software/model may also be executable to allow secondary processor to extract an encryption key used by the ransomware, which may enable file recovery subsequent to the detection and halting operation of primary processor 220.

Some embodiments of a ransomware detection system may optionally include additional power measurement devices to measure power and generated quantized signals that may provide additional information for the detection of ransomware. In this particular example, power measurement device 235 is coupled to measure power variations to network interface 237, while power measurement device 242 measures power variations to storage device 240. These power measurement devices may be similarly configured to power measurement device 205, generating samples and digital signals in a like manner. Using the additional digital signals from these extra power measurement devices may allow for more accurate detection of ransomware and may help eliminate false positives.

Many variations of the basic ransomware detection system are possible and contemplated. One possible variation is related to server machines, which typically have an out-of-band remote management system integrated therein. The server may include a separate processor that can be used for functions such as powering on/off the machine, monitoring sensors that measure the temperature, power, humidity etc., access system logs, mount drives, and remote logging in (for system administrators) using the management interface. This processor may be used as the secondary processor of a ransomware detection system if it has sufficient computational resources to run the ransomware classifier.

As further discussed above in reference to FIG. 2, the ransomware detection system can collect power signals from other devices on the motherboard, such as disk and network cards, in order to improve the accuracy and reduce the False Positive Rate (FPR) of the ransomware classifier. One way to do this that can lead to being able to differentiate different sources is by multiplying the bandlimited device signal by a frequency signal so as to easily separate them during processing. This can be done for all signals originating from different devices except one. Thereafter, all signals that have been multiplied by a frequency may be added together and sent to a single ADC. It is assumed that the ADC sampling rate is large enough so as to accommodate the largest frequency band in the input signal to the ADC. Thus, if we have signals s1, s2, . . . sn, we can multiply each one of them by a complex sinusoidal e^{jw_1x}, e^{jw_2x}, ...e^{jw_nx}, where w_i defines the frequency of the complex sinusoid associated with signal s_i. This effectively performs a frequency modulation for each signal from a different one of the devices for which power variations are being monitored.

In embodiments in which power signals are collected from multiple devices, such power signals may be used to correlate and confirm the possibility of an attack. For example, a server using transport layer security (TLS) might be using AES (Advanced Encryption Standard) encryption continuously, which will show strong fingerprint in the processor power signal. In contrast, if a ransomware runs, it may show strong fingerprint in both processor and disk power signals. More generally, if signals from two or more sources are complementing each other in showing ransomware presence for an extended period of time, it may indicate a higher probability of a ransomware attack, and thus reduce the possibility of false positives.

In various embodiments, a ransomware detection system may utilize other side channels, such as electromagnetic energy radiated by the processor, either separately or in conjunction with power signals in order to improve the accuracy and reduce the FPR of the ransomware classifier. Other side channels may include timing, temperature, vibration, sound, or optical emissions.

In certain embodiments, if the computational resources (processor or memory) required for the ransomware classifier are not available locally on the machine, the secondary processor or controller can upload the signal data to the cloud, where more powerful systems (e.g., in a data center) can run the classifier. Alternatively, a central computer within a server room could also be used for the computations of multiple servers and/or other computers coupled to a common network.

In order to improve the accuracy and reduce the FPR of the ransomware classifier, signal data can be continuously uploaded to another system or the cloud for training the classifier. This may include updating the classifier model on the non-volatile memory that operates exclusively with the secondary processor.

Upon detection of ransomware activity on the primary processor, the secondary processor can send commands to a controller for a non-volatile memory associated with the primary processor to direct it to begin backing up files that are being modified. These files can be stored in a separate partition that is not accessible to applications running on the primary processor and may be used for recovery from the ransomware attack. Furthermore, using, e.g., a caching system, the files that were already encrypted before detecting the ransomware may be recovered as well. In this approach every file that is overwritten will be kept in a cache for a certain amount of time (typically the detection time of the ransomware detector), in order to allow recovery. Alternate embodiments are also possible and contemplated in which file backups are made continuously, irrespective of any ransomware detection. This in turn may enable the recovery of the backed up files as they existed prior to any ransomware infection/attack.

In various embodiments, the ransomware detection system connect to other machines through the secondary network in order to transmit or receive alerts regarding ransomware activity and coordinate the response based on perceived risk and security posture. Furthermore, measurements from multiple systems could be correlated to identify abnormal behavior and targeted attacks more accurately.

In some embodiments, instead of completely shutting down the primary processor, the secondary processor may only slow down the primary processor's system. This could be achieved by, e.g., reducing the processor clock frequency, reducing the disk speed, reducing the PCIe frequency, limiting the network bandwidth. This may allow for further assessment of the potential ransomware. As an alternative, in situations where the ransomware is detected with low confidence, the secondary processor may scale the frequency of the primary processor to reduce its operating speed and obtain a lower frequency measurement and slow the progress of ransomware damage. The lower frequency measurement may improve accuracy of the detection model.

The ransomware detection system may also be applicable to laptops and desktop computers. Some computer system integrate management engines which could be used to achieve similar features. Furthermore, the ransomware detection system can be used in switches/routers, industrial computers/machines, medical computers, and other systems that are frequent targets of malware and ransomware.

In embodiments of the ransomware detection system in which the secondary network interface is implemented as an antenna and a transmitter that modulates the signal communicating the features, the decision of the detection or a mix of these may be, at least in part, offloaded to a third remote computer for further processing. The antenna may be implemented as a coil wrapped around the secondary processor or a loop connected to the secondary processor.

The input power signals provided to various components such as the processor, the DRAM, storage units, etc., may also be used to extract the encryption keys used by the ransomware. If the ransomware detector confirms the attack after the fact, corrupted files can be recovered via recovering their corresponding symmetric keys by applying machine learning-based side channel models. This key recovery can run in tandem with non-volatile memory-based file recovery (as discussed above) to aggressively track and recover all the files.

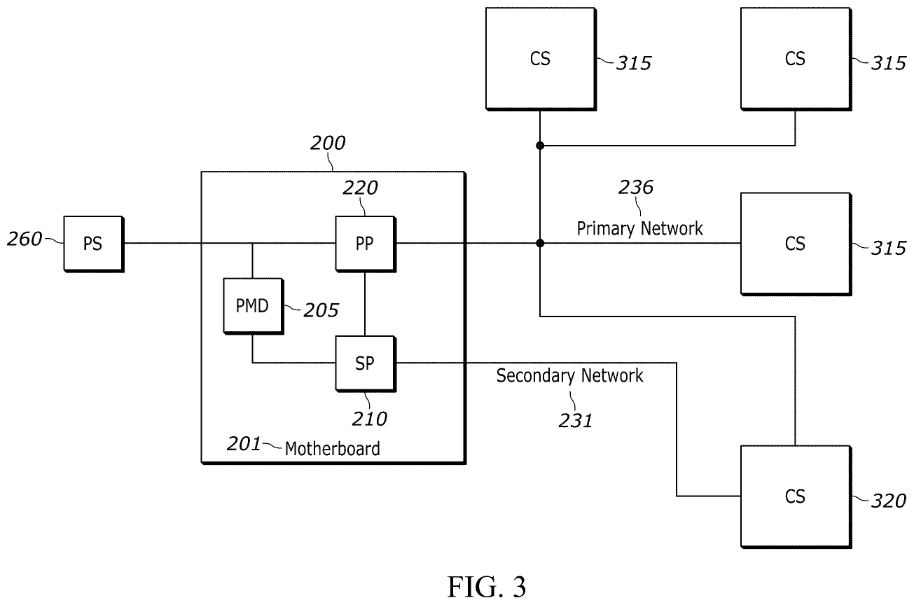

FIG. 3 is a block diagram illustrating a number of networked computers including at least one having a ransomware detection system implemented thereon, in accordance with the disclosure. More particularly, FIG. 3 illustrates a computer system 200 comprising motherboard 201 in the context of a network of computer. The computers, including computer system 200, multiple instances of computer system 315, and computer system 320, are connected to one another via a primary network 236.

In this particular example, the various instances of computer system 315 may be similar or the same as computer system 200, and may include a ransomware detection system. Computer system 320 as shown here may be a server or other type of computer system operated and maintained by a system administrator, and thus may carry out network administration functions. Accordingly, computer system 320 as shown here may communicate with secondary processor 210 via secondary network 231. Although not explicitly shown here, other instances of computer system 315 may also include a ransomware detection system that includes a secondary processor that may be coupled to communicate with computer system 320 via secondary network 231.

As a computer used for network administration functions, computer system 320 may operate in conjunction with the ransomware detection system on computer system 200. For example, in response to detecting ransomware, secondary processor 210 of computer system 200 may send alerts of the detection to computer system 320 such that other computers on primary network 236 can be alerted to the potential presence of ransomware or that network access can be temporarily suspended. As noted above, in some embodiments, secondary processor 210 may provide information for additional processing to determine the presence of ransomware, with such additional processing being carried out on a processor of computer system 320. When previously unknown ransomware is detected on any computer connected to primary network 236, computer system 320 may respond by pushing updates to the ransomware detection model to various ones of the other computers shown. The updates may be based on information received from the computer system upon which ransomware was detected, with such information including modified files, signatures of power signals, and so on. Generally speaking, computer system 320 may augment the ransomware detection and prevention functions carried out on various ones of the computer systems to provide a more robust prevention and detection mechanism.

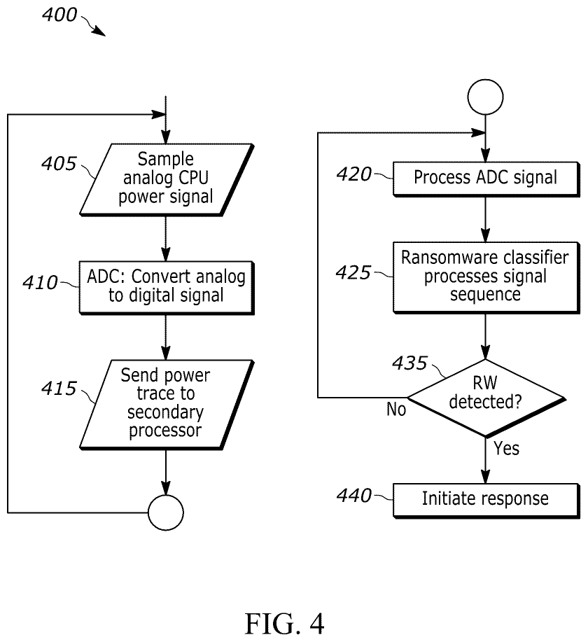

FIG. 4 is a flow diagram illustrating an embodiment of a method for operating a ransomware detection system. Method 400 as shown in FIG. 4 may be carried out by various embodiments of a ransomware detection system as discussed above. Embodiments of a ransomware detection system not explicitly discussed herein, but otherwise capable of carrying out Method 400, are considered to fall within the scope of this disclosure.

Method 400 includes the sampling of analog power signals provided to a central processing unit (CPU; block 405). The analog power signals may be conveyed on a power bus to the CPU. Sampled signals may then be converted into digital signals using an ADC circuit (block 410). In converting the samples into digital signals, variations in the power may be captured, and these variations may thus generate a signature that corresponds to a program executing on the CPU. The digital signals (referred to in the drawing as a power trace) may then be conveyed to a secondary processor (block 415).

The secondary processor may process the signals received from the ADC (block 420). This processing may include carrying out functions such as performing filtering (e.g., bandpass filtering) to limit the signals to be analyzed to a frequency band of interest. Other digital signal processing functions, such as applying Fast Fourier Transforms (FFTs) may also be carried out. The secondary processor may also execute ransomware detection software that includes a classifier as part of a ransomware detection model. Accordingly, the ransomware processor may process the digital signals (block 425) to determine if ransomware is executing on the CPU. If no ransomware is detected from a given instance of processing (block 435, no), then the method returns to block 420 for the processing of another set of signals received from the ADC. If ransomware is detected (block 435, yes), then the secondary processor initiates a response (block 440). The response may include halting execution of instructions by the CPU, powering off the CPU, or any of the other various actions discussed above.

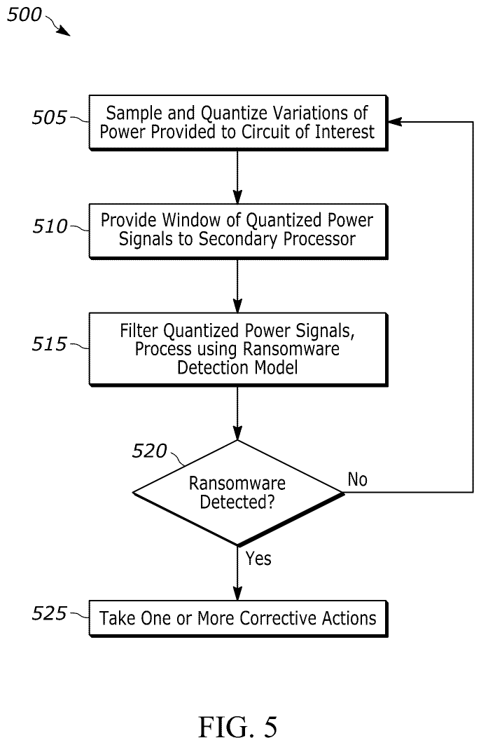

FIG. 5 is a flow diagram illustrating another embodiment of a method for operating a ransomware detection system. Method 500 as shown in FIG. 5 may be carried out by any of the embodiments of a ransomware detection system as discussed above. Embodiments of a ransomware detection system capable of carrying out Method 500, but not otherwise discussed herein, are also considered to fall within the scope of this disclosure.

Method 500 includes sampling and quantizing variation of power provided to a circuit of interest (block 505). The sampling may be carried out by, e.g., measuring variations in voltage or current on a power bus providing power to the circuit of interest. The quantizing may be carried using an ADC circuit to convert the analog measurements into digital signals. The circuit of interest may be a processor/CPU configured to execute program instructions, but may also be a network interface, a storage device, a memory subsystem, and so on.

After sampling and quantizing the power measurements, a window (group) of quantized power signals are provided to a secondary processor (block 510). The window may comprise samples taken over a specified time interval. In alternate embodiments, quantized power signals may be provided to the secondary processor in a continuous stream. The secondary processor may be a secure processor that is not visible to operating system software or to other programs that may be executing on a primary processor/CPU of the system.

After receiving the quantized power signals, the secondary processor may filter and process the signals using a ransomware detection model (block 515). The filtering may be carried out by, e.g., a bandpass filter, to focus on frequencies of interest while getting rid of signals that are not within the frequency band of interest. The ransomware detection model may carry out various functions, including determining a signature of the quantized power signals and comparing that with signatures that correspond to ransomware. If ransomware is not detected as a result of the processing (block 520, no), Method 500 returns to block 505 and continues. If ransomware is detected (block 520, yes), the secondary processor may initiate one or more corrective actions (block 525). The corrective actions may include inhibiting the processor/CPU from executing instructions, removing power from the processor/CPU, causing modified files to be backed up (for future recovery), and so on. Alerts may also be generated and conveyed over a network to a network server so that other computers on the network may be warned of the ransomware attack.

As an alternative to signature comparison, embodiments are possible and contemplated in which a model provides a classification output or probability of the likelihood that the power consumption as detected correspond to ransomware. In embodiments in which a probability is utilized, the value thereof is compared to a threshold, with the software that cause the power consumption patterns being classified as ransomware should it meet or exceed the threshold value. Such embodiments may dispense with the storage of signatures.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. An apparatus for detecting ransomware attacks in a computer system, the apparatus comprising:
a power measurement circuit implemented on a motherboard of a computer system, wherein the power measurement circuit is coupled to a power bus configured to convey power from a power supply to a primary processor implemented on the motherboard, wherein the power measurement circuit is configured to, during execution of a program by the primary processor, generate quantized power signals based on samples of the power conveyed on the power bus;
a non-volatile memory configured to store at least one ransomware detection model; and
a secondary processor coupled to the non-volatile memory and the power measurement circuit, wherein the secondary processor is configured to, using the quantized power signals, execute the ransomware detection model and, in response to detecting that the program executed by the primary processor is ransomware, inhibit the primary processor from further instruction execution.

2. The apparatus of claim 1, wherein the power measurement circuit includes:
a sampling circuit configured to generate samples based on variations of the power signals; and
an analog-to-digital converter (ADC) circuit configured to convert the variations of the power signals into the quantized power signals.

3. The apparatus of claim 2, wherein the sampling circuit comprises a resistive element coupled between the power supply and the primary processor, wherein the ADC is configured to sample variations in a voltage across the resistive element.

4. The apparatus of claim 2, wherein the secondary processor is configured to cause adjustment to one or more operating parameters of the ADC circuit:
a sampling rate; and
quantization levels of the ADC.

5. The apparatus of claim 1, wherein the secondary processor is configured to perform bandpass filtering of quantized power signals in a band comprising frequencies of interest.

6. The apparatus of claim 1, wherein, in executing the ransomware detection model, the secondary processor is configured to execute a classifier model.

7. The apparatus of claim 1, wherein the secondary processor is configured to, in response to detecting ransomware executing on the primary processor, generate a response, based on a security policy, to a remote computer system via a secondary network separate from a primary network that is configured for communications with the primary processor.

8. The apparatus of claim 1, wherein the secondary processor is configured to store detection logs in the non-volatile memory, and wherein the non-volatile memory is configured for exclusive use by the secondary processor.

9. The apparatus of claim 1, further comprising a dedicated random access memory coupled to the secondary processor and configured for exclusive use by the secondary processor.

10. The apparatus of claim 1, wherein the secondary processor is configured to, in response to detecting ransomware executing on the primary processor, perform one or more of the following:
convey a command to the primary processor to back up one or more files modified by the primary processor; and
extract an encryption key used by the ransomware.

11. A method for detecting ransomware attacks in a computer system, the method comprising:
sampling, using a power measurement circuit implemented on a motherboard of a computer system, power signals conveyed from a power supply to a primary processor that is implemented on the motherboard, wherein the sampling comprises generating a plurality of samples;
quantizing, using the power measurement circuit, the plurality of samples to generate a plurality of quantized power signals;
storing, on a non-volatile memory, a ransomware detection model;
executing, by a secondary processor implemented on the motherboard and using the quantized power signals, the ransomware detection model; and
inhibiting, by the secondary processor and during execution of the ransomware detection model, further instruction execution by the primary processor in response to detecting ransomware executing on the primary processor.

12. The method of claim 11, wherein sampling the power signals conveyed from the power supply to the primary processor and quantizing the samples comprises:
measuring variations in a voltage across a resistive element coupled between the power supply and the primary processor; and
converting, using the variations in the voltage into the quantized power signals using an analog-to-digital converter circuit.

13. The method of claim 11, wherein executing the ransomware detection model by the secondary processor comprises executing a classifier model.

14. The method of claim 11, further comprising extracting, by the secondary processor and in response to detecting ransomware executing on the primary processor, encryption keys used by the ransomware.

15. The method of claim 11, further comprising conveying, in response to detecting ransomware executing on the primary processor and using the secondary processor, convey, based on a security policy, a response to a remote computer via a secondary network separate from a primary network communicatively coupled to the primary processor.

16. The method of claim 11 further comprising:
restricting access to the non-volatile memory exclusively to the secondary processor; and
storing, in the non-volatile memory by the secondary processor, detection information in response to detecting ransomware executing on the primary processor.

17. The method of claim 11, further comprising:
conveying a command, by the secondary processor, to the primary processor in response to detecting ransomware executing on the primary processor; and
performing a backup, by the primary processor, of one or more files modified by the primary processor.

18. A system for detecting ransomware attacks, the system comprising:
a plurality of power measurement circuits configured to measure variations in power provided to corresponding ones of a plurality of circuits implemented in a computer system, the plurality of power measurement circuit including a first power measurement circuit configured to measure variations in power provided to a primary processor of the computer system and further configured to generate a first plurality of quantized power signals based on the variations in power provided to the primary processor;
a non-volatile memory configured to store at least one ransomware detection model; and
a secondary processor coupled to the non-volatile memory and the first power measurement circuit, wherein the secondary processor is configured to, using the first plurality of quantized power signals, execute the ransomware detection model and, in response to detecting that ransomware is executing on the computer system, inhibit the primary processor from further instruction execution.

19. The system of claim 18, wherein the plurality of power measurement circuits further comprises:
a second power measurement circuit configured to measure variations in power provided to a bulk storage device of the computer system, the bulk storage device being communicatively coupled to the primary processor, and further configured to generate a second plurality of quantized power signals based on the variations in the power provided to the bulk storage device; and
a third power measurement circuit configured to measure variations in power provided to a primary network interface, the primary network interface being communicatively coupled to the primary processor, and further configured to generate a third plurality of quantized power signals based on the variations in the power provided to the primary network interface;
wherein the secondary processor is configured to determine if ransomware is executing on the computer system based on the first, second, and third pluralities of quantized power signals.

20. The system of claim 19, wherein the first, second, and third power measurement circuits each include:
a sampling circuit configured to generate samples based on variations of in a measured electrical quantity; and
an analog-to-digital converter circuit (ADC) configured to convert the variation of the power signals into quantized power signals.
